(19) United States
(12) Patent Application Publication
(10) Pub. No.: US 2025/0309991 A1
(43) Pub. Date: Oct. 2, 2025

(54) MEASUREMENT APPLICATION DEVICE, SIGNAL FILTER DEVICE, AND METHOD

(71) Applicant: Rohde & Schwarz GmbH & Co. KG, München (DE)

(72) Inventors: Sven BARTHEL, Chemnitz (DE); Christoph HOLZLEITNER, München (DE)

(21) Appl. No.: 18/620,474

(22) Filed: Mar. 28, 2024

(51) Int. Cl. H04B 10/54; H04B 10/524

(52) U.S. Cl. CPC H04B 10/541; H04B 10/524

(57) ABSTRACT

The present disclosure provides a measurement application device comprising a signal input interface configured to receive a pulse-amplitude modulated signal with a predetermined number of characterizing signal levels, PAM-N signal, a signal mapper coupled to the signal input interface, wherein the signal mapper is configured to map each one of the characterizing signal levels of the PAM-N signal to a specific signal level representation, a display device coupled to the signal mapper, and configured to display the specific signal level representations. The present disclosure further provides a signal filter device, and a respective method.

### TECHNICAL FIELD

The disclosure relates to a measurement application device, a signal filter device, and a respective method.

### BACKGROUND

Although applicable to any type of measurement application device, the present disclosure will mainly be described in conjunction with signal acquisition devices that allow a user to visually inspect a signal.

In modern communication technologies different signal transmission systems may be used. A possible signal transmission system may employ so called PAM signals. However, PAM signals with a plurality of different signals levels are difficult to analyze.

Accordingly, there is a need for simplifying signal analysis.

### SUMMARY

The above stated problem is solved by the features of the independent claims. It is understood, that independent claims of a claim category may be formed in analogy to the dependent claims of another claim category.

Accordingly, it is provided:

A measurement application device comprising a signal input interface configured to receive a pulse-amplitude modulated signal with a predetermined number of characterizing signal levels, PAM-N signal, a signal mapper coupled to the signal input interface, wherein the signal mapper is configured to map each one of the characterizing signal levels of the PAM-N signal to a specific signal level representation, a display device coupled to the signal mapper, and configured to display the specific signal level representations.

Further, it is provided:

A signal filter device comprising an input interface configured to receive a pulse-amplitude modulated signal with a predetermined number of characterizing signal levels, PAM-N signal, a pass-through filter coupled to the signal input interface and configured to filter the PAM-N signal, and an output interface configured to output the filtered PAM-N signal, wherein the pass-through filter is configured to only pass through signal pulses of the PAM-N signal that comprise at least one of: at least one of a number of predetermined signal levels, and at least one of a number of predetermined signal level steps.

Further, it is provided:

A method for processing a signal, the method comprising receiving a pulse-amplitude modulated signal with a predetermined number of characterizing signal levels, PAM-N signal, mapping each one of the characterizing signal levels of the PAM-N signal to a specific signal level representation, and displaying the specific signal level representations.

The present disclosure is based on the finding that analyzing PAM-N signals i.e., pulse-amplitude modulated signals with a number N of different characterizing signal levels, becomes increasingly difficult with an increasing number of characterizing signal levels. Usually, eye diagrams and histograms are used to analyze the signal quality of such PAM-N signals, which may become difficult to read with an increasing number of characterizing signal levels. Further, a fully decoded digital data stream i.e., zeros and ones, is usually provided when analyzing a PAM-N signal.

The present disclosure, therefore, provides a measurement application device that allows to easily analyze PAM-N signals. To this end, the measurement application device comprises a signal input interface that is coupled to a signal mapper. The signal mapper is coupled to a display device.

During operation of the measurement application device, the signal input interface receives a pulse-amplitude modulated signal with a predetermined number of characterizing signal levels, PAM-N signal. The signal mapper maps each one of the characterizing signal levels of the PAM-N signal to a specific signal level representation. The display device then displays the specific signal level representations to a user.

The signal mapper may receive the PAM-N signal via the signal input interface and may determine the characterizing signal level that the PAM-N signal comprises for each signal period of the PAM-N signal. The signal mapper may then relate i.e., map, every characterizing signal level to a specific signal level representation. As will be indicated in more detail below, the signal level representations refer to visually distinctive representations that may visually easily be differentiated. The signal level representations are then displayed to a user via the display device.

Especially, if an expected sequence of characterizing signal levels is known in advance, with the signal level representations a user may easily compare the received PAM-N signal with the known expected characterizing signal levels, to determine the validity or correctness of the received PAM-N signal.

The signal input interface may be provided as an analog signal acquisition interface of the measurement application device that may be used to acquire the PAM-N signal. Alternatively, the signal input interface may also be provided as a digital data interface that receives a digital representation of the PAM-N signal. Such a digital representation may comprise a digital representation of the waveform of the PAM-N signal, or may comprise the digital data that is transmitted in the PAM-N signal. In case that the PAM-N signal is provided as digital representation of the waveform of the PAM-N signal, the measurement application device may comprise a decoder that is coupled to the signal input interface to decode the PAM-N signal and provide the decoded PAM-N signal to the signal mapper.

The signal mapper may comprise or may be provided in or as part of at least one of a dedicated processing element e.g., a processing unit, a microcontroller, a field programmable gate array, FPGA, a complex programmable logic device, CPLD, an application specific integrated circuit, ASIC, or the like. A respective program or configuration may be provided to implement the required functionality. The signal mapper may at least in part also be provided as a non-transitory computer program product comprising computer readable instructions that may be executed by a processing element. In a further embodiment, the signal mapper may be provided as addition or additional function or method to the firmware or operating system of a processing element that is already present in the respective application as respective computer readable instructions. Such computer readable instructions may be stored in a memory that is coupled to or integrated into the processing element. The processing element may load the computer readable instructions from the memory and execute them. The same applies to any other element, unit or function disclosed herein as part of the measurement application device, and the method, like the comparator, and the pass-through filter, the sorting unit, and the signal display processor.

In addition, it is understood, that any required supporting or additional hardware may be provided like e.g., a power supply circuitry and clock generation circuitry.

Generally, any computer program or computer program product disclosed herein is to be understood as a non-transitory computer program product.

The signal mapper may comprise a look-up-table that may be used to look up the signal level representation for each one of the characterizing signal levels when they arrive at the signal mapper. The signal mapper may also comprise a connection to an external database that nay provide the signal level representations to the signal mapper for specific characterizing signal levels.

After determining the signal level representations, the signal mapper provides the signal level representations to the display device for displaying to a user.

In embodiments, the measurement application device may further comprise a comparator. Such a comparator may compare the received PAM-N signal i.e., the content received within the PAM-N signal, to an expected content or sequence of signal level representations. The comparator may then mark the signal level representations of the received PAM-N signal that do not conform or do not fit the expected content of sequence of signal level representations. In addition, or as alternative, the comparator may also mark the signal level representations of the received PAM-N signal that do conform or do fit the expected content of sequence of signal level representations, respectively. Mark in this regard may refer to providing respective data for each of the signal level representations that may then be visually displayed by the display device. Such data may comprise actual image data or a flag that may be evaluated by a controller of the display device.

A measurement application device according to the present disclosure may comprise any device that may be used in a measurement application to acquire an input signal or to generate an output signal, or to perform additional or supporting functions in a measurement application. A measurement application device may also comprise or be implemented as program application or program applications, also called measurement program application or measurement program applications, that may be executed on a computer device and that may communicate with other measurement application devices in order to perform a measurement task. A measurement application, also called measurement setup, may e.g., comprise at least one or multiple different measurement application devices for performing electric, magnetic, or electromagnetic measurements, especially on single devices under test. Such electric, magnetic, or electromagnetic measurements may e.g., be performed in a measurement laboratory or in a production facility in the respective production line. An exemplary measurement application or measurement setup may serve to qualify the single devices under test i.e., to determine the proper electrical operation of the respective devices under test.

Measurement application devices to this end may comprise at least one signal acquisition section for acquiring electric, magnetic, or electromagnetic signals to be measured from a device under test, or at least one signal generation section for generating electric, magnetic, or electromagnetic signals that may be provided to the device under test. Such a signal acquisition section may comprise, but is not limited to, a front-end for acquiring, filtering, and attenuating or amplifying electrical signals. The signal generation section may comprise, but is not limited to, respective signal generators, amplifiers, and filters. In embodiments, the signal acquisition is performed via the signal acquisition section in a wired or contact-based manner or fashion. To this end, a respective measurement probe may be coupled to the measurement application device via a respective cable. In embodiments, the signal generation and emission are performed via the signal generation section in a wired or contact-based manner or fashion. To this end, a respective signal output probe may be coupled to the measurement application device via a respective cable, or the signal may be output directly via the cable e.g., to a device under test.

Further, when acquiring signals, measurement application devices may comprise a signal processing section that may process the acquired signals. Processing may comprise converting the acquired signals from analog to digital signals, and any other type of digital signal processing, for example, converting signals from the time-domain into the frequency-domain.

The measurement application devices may also comprise a user interface to display the acquired signals to a user and allow a user to control the measurement application devices. Of course, a housing may be provided that comprises the elements of the measurement application device. It is understood, that further elements, like power supply circuitry, and communication interfaces may be provided.

A measurement application device may be a stand-alone device that may be operated without any further element in a measurement application to perform tests on a device under test. Of course, communication capabilities may also be provided for the measurement application device to interact with other measurement application devices.

A measurement application device may comprise, for example, a signal acquisition device e.g., an oscilloscope, especially a digital oscilloscope, a spectrum analyzer, or a vector network analyzer. Such a measurement application device may also comprise a signal generation device e.g., a signal generator, especially an arbitrary signal generator, also called arbitrary waveform generator, or a vector signal generator. Further possible measurement application devices comprise devices like calibration standards, or measurement probe tips.

Of course, at least some of the possible functions, like signal acquisition and signal generation, may be combined in a single measurement application device.

In embodiments, the measurement application device may comprise pure data acquisition devices that are capable of acquiring an input signal and of providing the acquired input signal as digital input signal to a respective data storage or application server. Such pure data acquisition devices not necessarily comprise a user interface or display. Instead, such pure data acquisition devices may be controlled remotely e.g., via a respective data interface, like a network interface or a USB interface. The same applies to pure signal generation devices that may generate an output signal without comprising any user interface or configuration input elements. Instead, such signal generation devices may be operated remotely via a data connection.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to independent claim 1 can be combined in all variations with each other and the disclosure of the description is not limited to the claim dependencies as specified in the claim set. Further, the features of the dependent claims referring to independent claim 1 may be combined with any of the features of the other independent claims or the dependent claims relating to any one of the other independent claims. In a respective method, respective method steps may perform the function of the respective apparatus elements, and in a respective apparatus, respective apparatus elements may perform the respective method steps.

In an embodiment, which can be combined with all other embodiments mentioned above or below, the PAM-N signal may comprise a PAM signal with more than four characterizing signal levels.

With an increasing number of characterizing signal levels in a PAM-N signal, the difficulty increases when trying to analyze a PAM-N signal. The teaching of the present disclosure may, therefore, especially be used in conjunction with PAM-N signals that comprise a high number i.e., more than four, characterizing signal levels. Of course, the teaching of the present disclosure may also be used with PAM-N signals that have four or less than four characterizing signal levels.

In a further embodiment, which can be combined with all other embodiments mentioned above or below, the measurement application device may comprise a pass-through filter. The pass-through filter may be one of:
coupled between the signal input interface and the signal mapper, and configured to only pass through signal pulses of the PAM-N signal that comprise at least one of one of a number of predetermined signal levels, and one of a number of predetermined signal level step sequences; and
coupled between the signal mapper and the display device, and configured to only pass through signal level representations that represent at least one of: one of a number of predetermined signal levels, and one of a number of predetermined signal level step sequences.

As explained above, the pass-through filter may operate on the received PAM-N signal, prior to the PAM-N signal being provided to the signal mapper. Alternatively, the pass-through filter may be provided after the signal mapper i.e., between the signal mapper, and the display device.

When being provided between the signal input interface, and the signal mapper, the pass-through filter may operate on the PAM-N signal in the form that is received via the signal input interface, or a pre-processed form. The PAM-N signal may e.g., be received as an analog signal, and the pass-through filter may comprise an analog filtering system, especially a configurable analog filtering system. In embodiments, the PAM-N signal may be received as digital representation of the analog waveform of the PAM-N signal. In such embodiments, the pass-through filter may filter the waveform in the digital domain. In further embodiments, the PAM-N signal may be received as decoded signal. In such embodiments, the pass-through filter may operate on the decoded signal and pass-through only respective signal values. In further embodiments, the received PAM-N signal may be pre-processed into the digital data that is provided in the PAM-N signal for the pass-through filter.

The pass-through filter may be configured to filter out signal pulses of the PAM-N signal that do not comprise at least one of: one of the number of predetermined signal levels, and the number of predetermined signal level steps.

The term “predetermined signal level” refers to any one of the number of predetermined signal levels that may be present in the PAM-N signal. The term “signal level step sequence” refers to a specific signal step that led to the respective predetermined signal level i.e., the sequence from the prior signal level to the current signal level. Such a sequence is defined by the former signal level and the current signal level.

For example, in a PAM-N signal with four predetermined signal levels, 1, 2, 3, and 4. In such a PAM-N signal, every one of the specific signal levels may be reached from three other signal levels. Possible signal level step sequences for signal level 1 comprise 2-1, 3-1, and 4-1. A signal level 1 may also be followed by a signal level 1. This explanation applies to the further predetermined signal levels mutatis mutandis.

In an embodiment, the pass-through filter may pass-through elements of the PAM-N signal purely based on the predetermined signal level that they represent. In other embodiments, the pass-through filter may pass-through elements of the PAM-N signal purely based on a respective signal level step sequence. Of course, the pass-through filter may be configured to pass-through elements of the PAM-N signal for multiple predetermined signal levels and/or multiple signal level step sequences.

In another embodiment, which can be combined with all other embodiments mentioned above or below, the measurement application device may further comprise a user interface configured to receive configuration data from a user, wherein the configuration data may indicate at least one of: at least one of the predetermined signal levels, and at least one of the predetermined signal level step sequences.

With the user interface, a user may configure the pass-through filter according to the requirements of a specific measurement application. The user interface may comprise input elements that may be present on the measurement application device, like buttons, knobs, switches, and a touch-screen display device.

In another embodiment, which can be combined with all other embodiments mentioned above or below, the measurement application device may further comprise a signal display processor coupled to the display device. The signal display processor may be further configured to control the display device to display the signal level representations in a dynamic waterfall diagram.

The term “dynamic waterfall diagram” refers to a waterfall diagram that adds newer elements of the PAM-N signal from one side to the dynamic waterfall diagram, while moving the already present elements of the PAM-N signal one step further e.g., from bottom to top of the display device, of from top to bottom, or from left to right, or right to left. In embodiments, the orientation of the dynamic waterfall diagram may be user configurable.

Such a dynamic waterfall diagram will look to the user as if it was moving over or scrolling through the PAM-N signal i.e., the signal level representations of the PAM-N signal.

In another embodiment, which can be combined with all other embodiments mentioned above or below, the signal display processor may further be configured to control the display device to display the signal level representations in a single column in the dynamic waterfall diagram.

A single-column dynamic waterfall diagram is simple to setup and display to a user.

In a further embodiment, which can be combined with all other embodiments mentioned above or below, the measurement application device may further comprise a sorting unit coupled to the display device, or between the signal mapper and the display device. The sorting unit may be configured to sort the signal level representations into multiple groups, and to provide the sorted signal level representations to the signal display processor. The signal display processor may be further configured to control the display device to display the sorted signal level representations in multiple parallel sections of the dynamic waterfall diagram according to the multiple groups.

The sorting unit may in embodiments add sorting data to the signal level representations. In embodiments, the sorting unit may also divide i.e., sort, the signal level representations into different signal streams or arrays that may then be provided to the signal display processor.

The dynamic waterfall diagram may comprise multiple parallel sections or lanes that may accommodate the grouped signal level representations. In such a dynamic waterfall diagram, all signal level representations of the same group may be shown in the same section or lane.

In an embodiment, a single lane may be provided for every group of signal level representations that comprise a specific signal level step sequence width. The signal level step sequence width refers to the distance between the prior characterizing signal level and the characterizing signal level represented by a signal level representation. In the above example of a 4-level or PAM-4 signal, the possible step widths are 0, 1, 2, and 3. A step width of 0 indicates the same characterizing signal level. A step width of 1 indicates that a step from 1 to 2, 2 to 3, 3 to 4 or vice versa was performed. A step width of 2 indicates that a step from 1 to 3, 2 to 4 or vice versa was performed. A step width of 3 indicates that a step from 1 to 4 or 4 to 1 was performed.

In another embodiment, which can be combined with all other embodiments mentioned above or below, each one of the parallel sections may refer to signal level representations that refer to a characterizing signal level comprising a specific signal level step sequence.

In such an embodiment, a dedicated section or lane may be provided for specific signal level step sequences. For example, a single or dedicated section or lane may be provided for the step 1-3, and the step 2-4, and the step 1-4. At the same time, a single section or lane may be provided for all signal level step sequences with a step width of 1. Of course, this is just an exemplary configuration, and any other sorting is possible.

In an embodiment, which can be combined with all other embodiments mentioned above or below, the signal display processor may be further configured to control the display device to display the signal level representations in the order of arrival of the characterizing signal levels in the PAM-N signal.

When displaying the signal level representations in the order of arrival of the characterizing signal level in the PAM-N signal, the user will see the actual sequence of the data as it arrived.

In a further embodiment, which can be combined with all other embodiments mentioned above or below, the signal display processor may be further configured to control the display device to display the signal level representations in a different order than the order of arrival of the characterizing signal levels in the PAM-N signal.

The signal level representations may be displayed e.g., in an order that represents some kind of signal quality metric or the like. This allows further grouping elements of the PAM-N signal for analysis by the user.

In another embodiment, which can be combined with all other embodiments mentioned above or below, each one of the signal level representations may comprise at least one of a predetermined shape, and a predetermined color, and a predetermined size.

The signal level representations may refer to any possible kind of visual representation that a user may visually perceive on the display device.

Possible signal level representation may comprise, but are not limited to, filled or non-filled circles, rectangles, ellipsis or the like. The single characterizing signal level may e.g., be indicated by the fill color and/or the border color of the shape. The size of the respective shape may refer or represent e.g., the signal level step sequence width. A shape that represents a characterizing signal level and a signal level step sequence width of 2 may be double the size, length or width than a shape that represents a characterizing signal level and a signal level step sequence width of 1.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a measurement application device according to the present disclosure;

FIG. 2 shows a block diagram of another embodiment of a measurement application device according to the present disclosure;

FIG. 3 shows a block diagram of another embodiment of a measurement application device according to the present disclosure;

FIG. 4 shows a block diagram of another embodiment of a measurement application device according to the present disclosure;

FIG. 5 shows a block diagram of an embodiment of a signal filter device according to the present disclosure;

FIG. 6 shows a flow diagram of an embodiment of a method according to the present disclosure;

FIG. 7 shows a block diagram of an embodiment of an oscilloscope that may be used as a measurement application device according to the present disclosure; and

FIG. 8 shows a block diagram of another embodiment of an oscilloscope that may be used as a measurement application device according to the present disclosure.

In the figures like reference signs denote like elements unless stated otherwise.

### DETAILED DESCRIPTION OF THE DRAWINGS

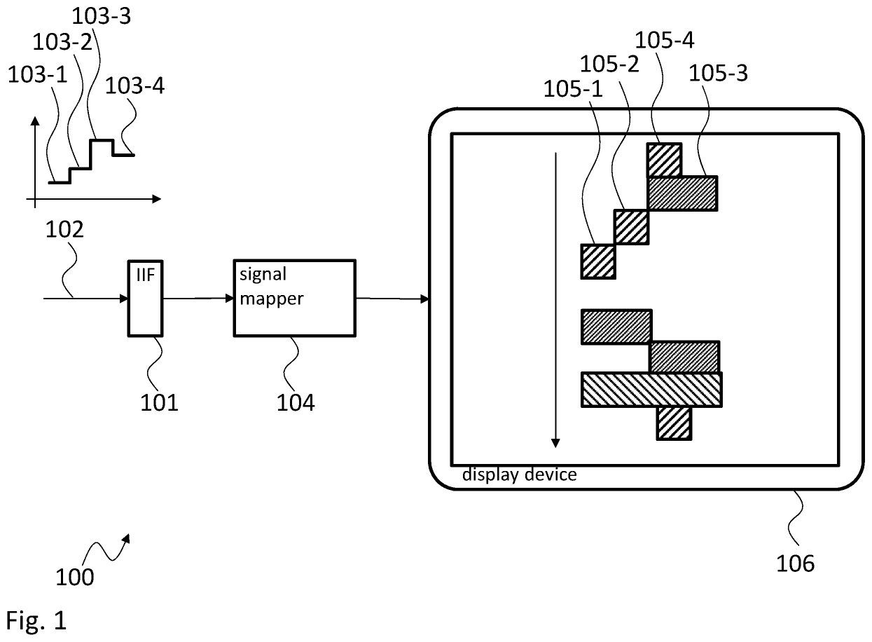

FIG. 1 shows a block diagram of a measurement application device 100. The measurement application device 100 comprises a signal input interface 101 that is coupled to a signal mapper 104. The signal mapper 104 is coupled to a display device 106. The signal input interface 101 receives a pulse-amplitude modulated signal 102 with exemplary four characterizing signal levels 103-1, 103-2, 103-3, 103-4. Such a signal may also be called PAM-4 signal 102. The signal mapper 104 maps each one of the characterizing signal levels of the PAM-4 signal to a specific signal level representation 105-1, 105-2, 105-3, 105-4, which may then be displayed on the display device 106. The explanations provided herein for any embodiment of the measurement application device apply mutatis mutandis to measurement application device 100.

An exemplary section of a PAM-4 signal 102 is shown above the signal input interface 101. This PAM-4 signal 102 comprises four characterizing signal levels 103-1, 103-2, 103-3, 103-4.

The display device 106 shows the specific signal level representation 105-1, 105-2, 105-3, 105-4 of the characterizing signal levels 103-1, 103-2, 103-3, 103-4 in the upper half. In the lower half an earlier section of the PAM-4 signal 102 is shown.

In the display device 106, the specific signal level representation 105-1, 105-2, 105-3, 105-4 are arranged in a single section or lane. In such an embodiment, the single specific signal level representations 105-1, 105-2, 105-3, 105-4 may overlap. This single section or lane may e.g., comprise four segments in each line, one segment per characterizing signal level 103-1, 103-2, 103-3, 103-4.

The single specific signal level representations 105-1, 105-2, 105-3, 105-4 shown on the display device 106 are square-shaped for a characterizing signal level 103-1, 103-2, 103-3, 103-4 and a signal level step sequence width of 1. For a signal level step sequence width of 2, a rectangle with double the width of the square is shown. For a signal level step sequence width of 3, although not present, a rectangle with three times the width of the square would be shown. For a signal level step sequence width of 4, a rectangle with four times the width of the square is shown. The specific signal level representations determines the shading, which in other embodiments may also be a color instead of a shading.

Although a PAM-4 signal is exemplarily shown in conjunction with measurement application device 100, it is understood that the PAM signal may comprise more than four characterizing signal levels in other embodiments.

The display device 106 shows the specific signal level representation 105-1, 105-2, 105-3, 105-4 in the order in which they arrive at the signal input interface 101. In other embodiments, the order may vary. To this end, a signal display processor may be provided, as indicated below in more detail.

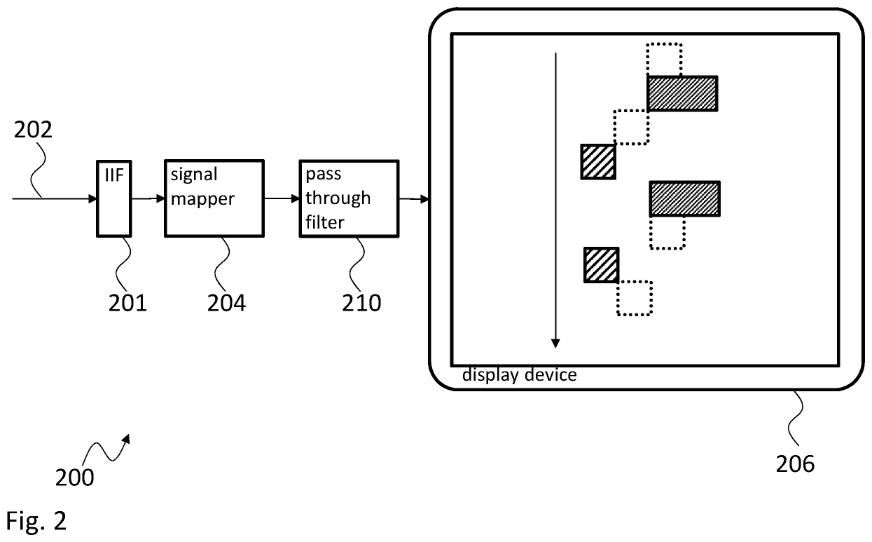

FIG. 2 shows a block diagram of a measurement application device 200. The measurement application device 200 is based on the measurement application device 100. Therefore, the measurement application device 200 comprises a signal input interface 201 that is coupled to a signal mapper 204. The signal mapper 204 is coupled to a display device 206. The signal input interface 201 receives a pulse-amplitude modulated signal 202 with a predetermined number of characterizing signal levels. The signal mapper 204 maps each one of the characterizing signal levels of the PAM-N signal to a specific signal level representation, which may then be displayed on the display device 206. The explanations provided herein for any embodiment of the measurement application device apply mutatis mutandis to measurement application device 200.

The measurement application device 200 further comprises a pass-through filter 210 that is arranged between the signal mapper 204, and the display device 206. In such an embodiment, the pass-through filter 210 only passes through signal level representations that represent at least one of one of a number of predetermined signal levels, and/or one of a number of predetermined signal level step sequences. Consequently, the pass-through filter 210 does not pass through signal level representations that represent other signal levels, or other predetermined signal level step sequences, which are hinted at by dotted boxes.

In further embodiments, the pass-through filter 210 may be provided between the signal input interface 201 and the signal mapper 204. In such embodiments, the pass-through filter 210 only passes through signal pulses of the PAM-N signal that comprise at least one of: one of a number of predetermined signal levels, and one of a number of predetermined signal level step sequences.

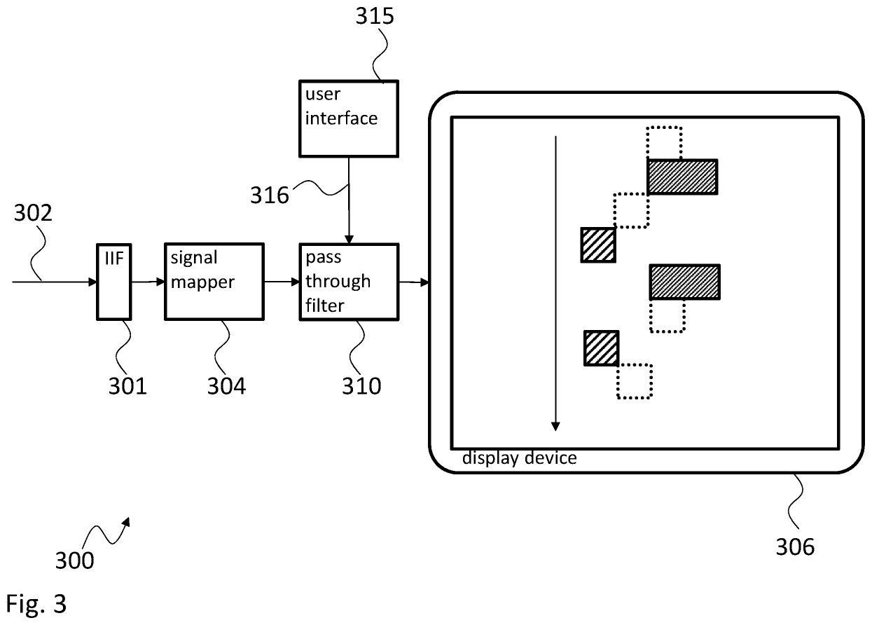

FIG. 3 shows a block diagram of a measurement application device 300. The measurement application device 300 is based on the measurement application device 100. Therefore, the measurement application device 300 comprises a signal input interface 301 that is coupled to a signal mapper 304. The signal mapper 304 is coupled to a display device 306. The signal input interface 301 receives a pulse-amplitude modulated signal 302 with a predetermined number of characterizing signal levels. The signal mapper 304 maps each one of the characterizing signal levels of the PAM-N signal to a specific signal level representation, which may then be displayed on the display device 306. The measurement application device 300 also comprises a pass-through filter 310 that is arranged between the signal mapper 304, and the display device 306. The explanations provided herein for any embodiment of the measurement application device apply mutatis mutandis to measurement application device 300.

The measurement application device 300 further comprises a user interface 315 that is coupled to the pass-through filter 310. The user interface 315 serves for receiving configuration data 316 from a user. The configuration data 316 may refer to at least one of the predetermined signal levels, and to at least one of the predetermined signal level step sequences that the pass-through filter 310 should pass-through or filter out.

The user interface 315 may be provided as an additional interface in the measurement application device 300. As alternative, the measurement application device 300 may also be implemented as interface elements that are already present in the measurement application device 300 e.g., a touch screen of the display device 306.

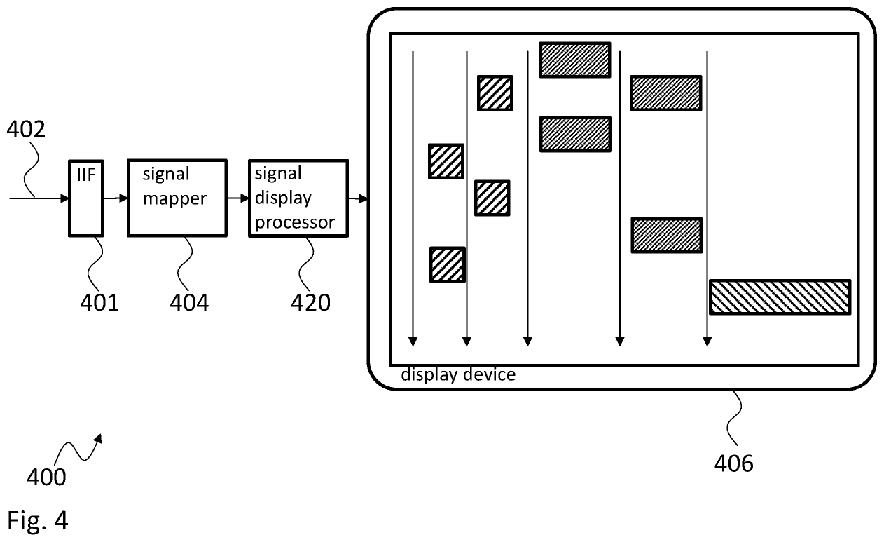

FIG. 4 shows a block diagram of a measurement application device 400. The measurement application device 400 is based on the measurement application device 100. Therefore, the measurement application device 400 comprises a signal input interface 401 that is coupled to a signal mapper 404. The signal mapper 404 is coupled to a display device 406. The signal input interface 401 receives a pulse-amplitude modulated signal 402 with a predetermined number of characterizing signal levels. The signal mapper 404 maps each one of the characterizing signal levels of the PAM-N signal to a specific signal level representation, which may then be displayed on the display device 406. The explanations provided herein for any embodiment of the measurement application device apply mutatis mutandis to measurement application device 400.

The measurement application device 400 further comprises a signal display processor 420 that is arranged between the signal mapper 404, and the display device 406. The signal mapper 404 serves for controlling the display device 406 to display the specific signal level representations in a specific way on the display device 406.

In the previous figures, the specific signal level representations are shown as overlapping. The display device 406, in contrast, shows every specific signal level representation in a separate lane or section. This allows more easily visually separating the single specific signal level representations.

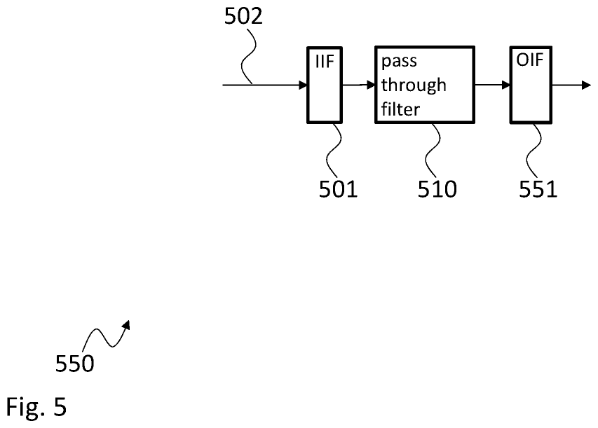

FIG. 5 shows a block diagram of an embodiment of a signal filter device 550. The signal filter device 550 comprises a signal input interface 501 that is coupled to a pass-through filter 510. The pass-through filter 510 is coupled to an output interface 551. The signal input interface 501 receives a pulse-amplitude modulated signal 502. The pass-through filter 510 filters the characterizing signal levels and outputs them via the output interface 551. The explanations provided herein for any embodiment of the signal input interface, and the pass-through filter apply mutatis mutandis to signal input interface 501, and pass-through filter 510.

The signal filter device 550 may be used as a stand-alone device or may be provided within a measurement application device, as required.

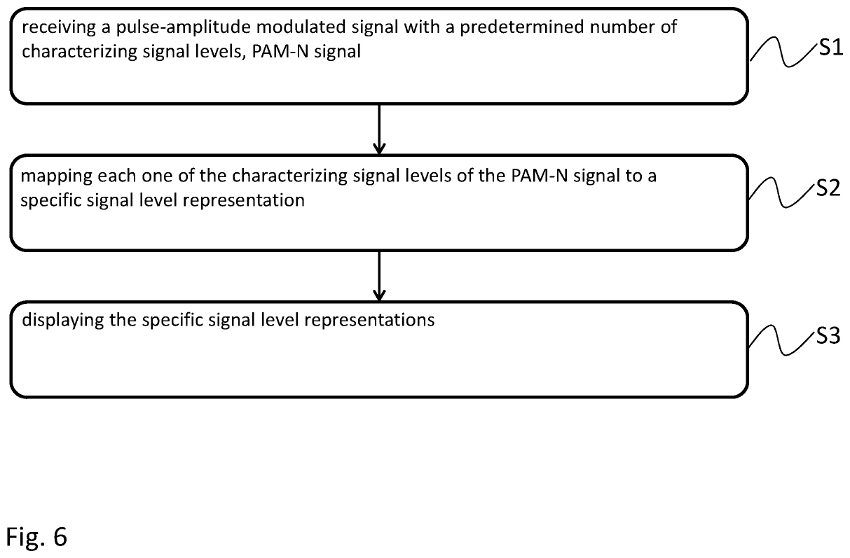

FIG. 6 shows a flow diagram of a method for processing a PAM-N signal. The method comprises receiving a pulse-amplitude modulated signal with a predetermined number of characterizing signal levels, PAM-N signal, mapping each one of the characterizing signal levels of the PAM-N signal to a specific signal level representation, and displaying the specific signal level representations.

The method may further comprise filtering the PAM-N signal by one of a) only passing through signal pulses of the PAM-N signal that comprise at least one of one of a number of predetermined signal levels, and one of a number of predetermined signal level step sequences; and b) only passing through signal level representations that represent at least one of one of a number of predetermined signal levels, and one of a number of predetermined signal level step sequences.

Further, the method may comprise controlling the step of displaying to display the signal level representations in a dynamic waterfall diagram, especially in a single column in the dynamic waterfall diagram.

The method may further comprise sorting the signal level representations into multiple groups, and controlling the step of displaying to display the sorted signal level representations in multiple parallel sections of the dynamic waterfall diagram according to the multiple groups.

Each one of the parallel sections may refer to signal level representations that refer to a characterizing signal level comprising a specific signal level step sequence.

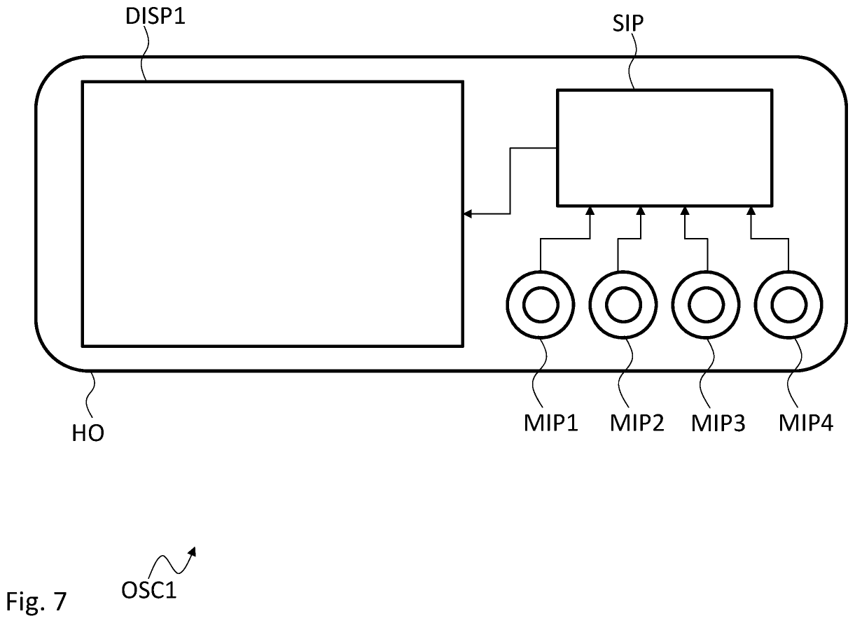

FIG. 7 shows a block diagram of an oscilloscope OSC1 that may be used with an embodiment of a measurement application device according to the present disclosure.

The oscilloscope OSC1 comprises a housing HO that accommodates four measurement inputs MIP1, MIP2, MIP3, MIP4 that are coupled to a signal processor SIP for processing any measured signals. The signal processor SIP is coupled to a display DISP1 for displaying the measured signals to a user.

Although not explicitly shown, it is understood, that the oscilloscope OSC1 may also comprise signal outputs. Such signal outputs may for example serve to output calibration signals. Such calibration signals allow calibrating the measurement setup prior to performing any measurement. The process of calibrating and correcting any measurement signals based on the calibration may also be called de-embedding and may comprise applying respective algorithms on the measured signals.

In the oscilloscope OSC1 the signal processor SIP or an additional processing element may perform the function of the signal mapper, the pass-through filter or any other element of the measurement application device according to the present disclosure, or may implement the signal mapper, the pass-through filter or any other element of the measurement application device. Of course, a communication interface may be provided in the oscilloscope OSC1 for communication with other measurement application devices.

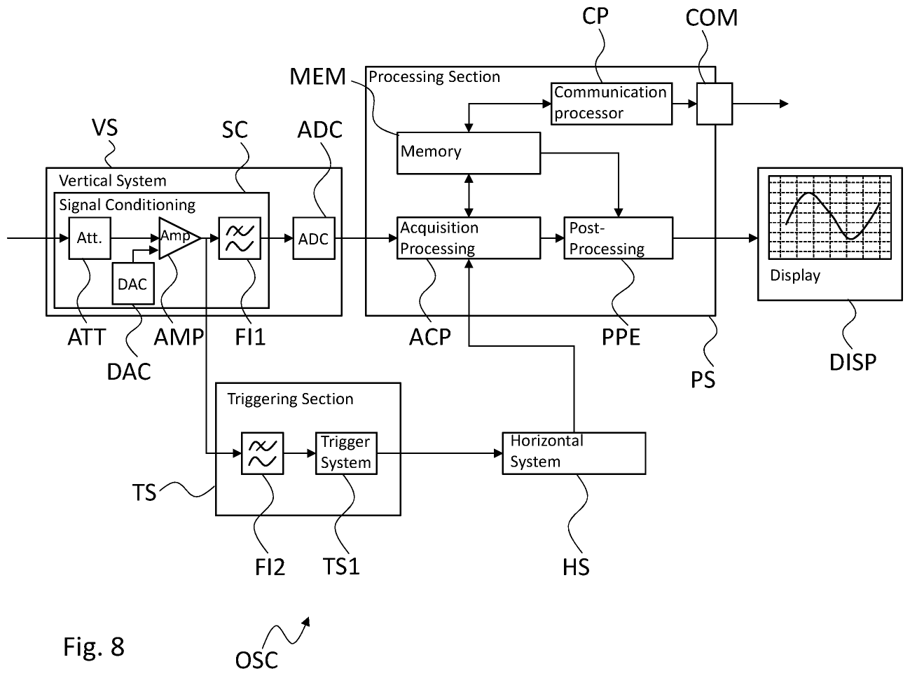

FIG. 8 shows a block diagram of an oscilloscope OSC that may be an implementation of a measurement application device according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS and the display DISP. It is understood, that the partitioning into five general sections is a logical partitioning and does not limit the placement and implementation of any of the elements of the oscilloscope OSC in any way.

The vertical system VS mainly serves for offsetting, attenuating and amplifying a signal to be acquired. The signal may for example be modified to fit in the available space on the display DISP or to comprise a vertical size as configured by a user.

To this end, the vertical system VS comprises a signal conditioning section SC with an attenuator ATT and a digital-to-analog-converter DAC that are coupled to an amplifier AMP. The amplifier AMP is coupled to a filter F11, which in the shown example is provided as a low pass filter. The vertical system VS also comprises an analog-to-digital converter ADC that receives the output from the filter F11 and converts the received analog signal into a digital signal.

The attenuator ATT and the amplifier AMP serve to scale the amplitude of the signal to be acquired to match the operation range of the analog-to-digital converter ADC. The digital-to-analog-converter DAC serves to modify the DC component of the input signal to be acquired to match the operation range of the analog-to-digital converter ADC. The filter F11 serves to filter out unwanted high frequency components of the signal to be acquired.

The triggering section TS operates on the signal as provided by the amplifier AMP. The triggering section TS comprises a filter F12, which in this embodiment is implemented as a low pass filter. The filter F12 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

In order to allow an exact matching of the trigger event and the waveform that is shown on the display DISP, a common time base may be provided for the analog-to-digital converter ADC and the trigger system TS1.

It is understood, that although not explicitly shown, the trigger system TS1 may comprise at least one of configurable voltage comparators for setting the trigger threshold voltage, fixed voltage sources for setting the required slope, respective logic gates like e.g., a XOR gate, and FlipFlops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the amplifier AMP but will operate on the digital signal as provided by the analog-to-digital converter ADC.

A digital triggering section may comprise a processing element, like a processor, a DSP, a CPLD, an ASIC or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC and the output of the horizontal system HS as well as to a memory MEM and a post processing element PPE.

The acquisition processing element ACP manages the acquisition of digital data from the analog-to-digital converter ADC and the storage of the data in the memory MEM. The acquisition processing element ACP may for example comprise a processing element with a digital interface to the analog-to-digital converter ADC2 and a digital interface to the memory MEM. The processing element may for example comprise a microcontroller, a DSP, a CPLD, an ASIC or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA opposed to software being executed by a processor.

The processing section PS further comprises a communication processor CP and a communication interface COM.

The communication processor CP may be a device that manages data transfer to and from the oscilloscope OSC. The communication interface COM for any adequate communication standard like for example, Ethernet, WIFI, Bluetooth, NFC, an infra-red communication standard, and a visible-light communication standard.

The communication processor CP is coupled to the memory MEM and may use the memory MEM to store and retrieve data.

Of course, the communication processor CP may also be coupled to any other element of the oscilloscope OSC to retrieve device data or to provide device data that is received from the management server.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user. The post processing element PPE may also realize analysis functions like cursors, waveform measurements, histograms, or math functions.

The display DISP controls all aspects of signal representation to a user, although not explicitly shown, may comprise any component that is required to receive data to be displayed and control a display device to display the data as required.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

In the oscilloscope OSC, any one of the processing elements in the processing section PS or an additional processing element may perform the function of the signal mapper, the pass-through filter or any other element of the measurement application device according to the present disclosure.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-describe logical functions may be implemented in any adequate hardware element of the oscilloscope OSC and not necessarily need to be partitioned into the different sections explained above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE SIGNS

100, 200, 300, 400 measurement application device
101, 201, 301, 401, 501 signal input interface
102, 202, 302, 402, 502 PAM-N signal
103-1, 103-2, 103-3, 103-4 characterizing signal levels
104, 204, 304, 404 signal mapper
105-1, 105-2, 105-3, 105-4 signal level representation
106, 206, 306, 406 display device
210, 310, 510 pass-through filter
315 user interface
316 configuration data
420 signal display processor
550 signal filter device
551 output interface
OSC1 oscilloscope
HO housing
MIP1, MIP2, MIP3, MIP4 measurement input
SIP signal processing
DISP1 display
OSC oscilloscope
VS vertical system
SC signal conditioning
ATT attenuator
DAC1 analog-to-digital converter
AMP amplifier
F11 filter
DAC digital-to-analog converter
ADC analog-to-digital converter
TS triggering section
AMP2 amplifier
F12 filter
TS1 trigger system
HS horizontal system
PS processing section
ACP acquisition processing element
MEM memory
PPE post processing element
DISP display

1. Measurement application device comprising:
a signal input interface configured to receive a pulse-amplitude modulated (PAM-N) signal with a predetermined number of characterizing signal levels;
a signal mapper coupled to the signal input interface, wherein the signal mapper is configured to map each one of the characterizing signal levels of the PAM-N signal to a specific signal level representation; and
a display device coupled to the signal mapper, and configured to display the specific signal level representations.

2. Measurement application device according to claim 1, wherein the PAM-N signal comprises a PAM signal with more than four characterizing signal levels.

3. Measurement application device according to claim 1, further comprising a pass-through filter, wherein the pass-through filter is one of:
coupled between the signal input interface and the signal mapper, and configured to only pass through signal pulses of the PAM-N signal that comprise at least one of one of a number of predetermined signal levels, and one of a number of predetermined signal level step sequences; or
coupled between the signal mapper and the display device, and configured to only pass through signal level representations that represent at least one of one of a number of predetermined signal levels, and one of a number of predetermined signal level step sequences.

4. Measurement application device according to claim 3, further comprising a user interface configured to receive configuration data from a user, wherein the configuration data indicates at least one of:
at least one of the predetermined signal levels; or
at least one of the predetermined signal level step sequences.

5. Measurement application device according to claim 1, further comprising a signal display processor coupled to the display device and configured to control the display device to display the signal level representations in a dynamic waterfall diagram.

6. Measurement application device according to claim 5, wherein the signal display processor is further configured to control the display device to display the signal level representations in a single column in the dynamic waterfall diagram.

7. Measurement application device according to claim 5, further comprising a sorting unit coupled to the display device and configured to sort the signal level representations into multiple groups, and to provide the sorted signal level representations to the signal display processor,
wherein the signal display processor is further configured to control the display device to display the sorted signal level representations in multiple parallel sections of the dynamic waterfall diagram according to the multiple groups.

8. Measurement application device according to claim 7, wherein each of the parallel sections refers to signal level representations that refer to a characterizing signal level comprising a specific signal level step sequence.

9. Measurement application device according to claim 5, wherein the signal display processor is further configured to control the display device to display the signal level representations in the order of arrival of the characterizing signal levels in the PAM-N signal.

10. Measurement application device according to claim 5, wherein the signal display processor is further configured to control the display device to display the signal level representations in a different order than the order of arrival of the characterizing signal levels in the PAM-N signal.

11. Measurement application device according to claim 1, wherein each one of the signal level representations comprises at least one of a predetermined shape, a predetermined color, or a predetermined size.

12. Signal filter device comprising:
an input interface configured to receive a pulse-amplitude modulated (PAM-N) signal with a predetermined number of characterizing signal levels;
a pass-through filter coupled to the signal input interface and configured to filter the PAM-N signal; and
an output interface configured to output the filtered PAM-N signal,
wherein the pass-through filter is configured to only pass through signal pulses of the PAM-N signal that comprise at least one of:
at least one of a number of predetermined signal levels; or
at least one of a number of predetermined signal level steps.

13. Signal filter according to claim 12, wherein the input interface comprises a digital interface, and
wherein the PAM-N signal is received as digital signal.

14. Signal filter according to claim 12, wherein the PAM-N signal comprises a PAM signal with more than four characterizing signal levels.

15. Signal filter according to claim 12, further comprising a configuration interface configured to receive configuration data that indicates at least one of:
at least one of the predetermined signal levels; or
at least one of the predetermined signal level steps.

16. Method for processing a signal, the method comprising:
receiving a pulse-amplitude modulated (PAM-N) signal with a predetermined number of characterizing signal levels;
mapping each one of the characterizing signal levels of the PAM-N signal to a specific signal level representation; and
displaying the specific signal level representations.

17. Method according to claim 16, further comprising filtering the PAM-N signal by one of:
a) only passing through signal pulses of the PAM-N signal that comprise at least one of:
one of a number of predetermined signal levels, or
one of a number of predetermined signal level step sequences; or
b) only passing through signal level representations that represent at least one of:
one of a number of predetermined signal levels, or
one of a number of predetermined signal level step sequences.

18. Method according to claim 16, further comprising controlling the step of displaying to display the signal level representations in a dynamic waterfall diagram.

19. Method according to claim 18, further comprising controlling the step of displaying to display the signal level representations in a single column in the dynamic waterfall diagram.

20. Method according to claim 18, further comprising sorting the signal level representations into multiple groups, and
controlling the step of displaying to display the sorted signal level representations in multiple parallel sections of the dynamic waterfall diagram according to the multiple groups.

21. Method according to claim 20, wherein each one of the parallel sections refers to signal level representations that refer to a characterizing signal level comprising a specific signal level step sequence.
